(19) United States
(12) Patent Application Publication
(10) Pub. No.: US 2020/0337804 A1
(43) Pub. Date: Oct. 29, 2020

(54) RETAINERLESS DENTAL MATRIX BAND SYSTEM

(71) Applicant: Rhondium IP Limited, Katikati (NZ)

(72) Inventor: Simon P McDonald, Katikati (NZ)

(73) Assignee: Rhondium IP Limited, Katikati (NZ)

(21) Appl. No.: 16/957,099

(22) PCT Filed: Dec. 24, 2018
(86) PCT No.: PCT/US18/67460

§ 371 Date: Jun. 22, 2020

(30) Foreign Application Priority Data
Dec. 22, 2017 (NZ) 738749
Feb. 9, 2018 (NZ) 739823

(51) Int. Cl. A61C 5/85

(52) U.S. Cl. CPC A61C 5/85

(57) ABSTRACT

A dental matrix band and tightening system is shown to comprise a matrix band, casing, actuator, and tensioner. Rotation of the actuator displaces the tensioner within the casing and draws additional length of the matrix band into the casing, thereby reducing the circumference of the matrix band and tightening the matrix band onto the tooth. The matrix band circumference is reduced in multiples of the displacement of the tensioner. The actuator and tensioner align on an axis parallel to the plane of the matrix band for ease of access and use.

### TECHNICAL FIELD

This invention relates generally to the field of dentistry and more specifically to the use of dental matrix bands in the restoration of teeth.

### BACKGROUND OF THE INVENTION

Dental matrix bands and the use of matrix band systems are well known and widely utilized in restorative dentistry. The purpose of using matrix bands is to provide a smooth surface against which the dentist can build the missing tooth. The matrix band is also required to tightly hug the natural tooth to prevent the unnecessary formation of ledges.

There are many types of matrix bands available. They are generally made of metal and/or plastic and are sectional or circumferential bands. Plastic matrix bands are thicker than metal matrix bands and this causes problems obtaining tight interproximal contacts. Thus, metal matrices have been popular, especially for posterior teeth.

Circumferential matrix bands have been in use longer than sectional matrix bands. Generally, circumferential matrix bands are used with a retainer. The function of the retainer is to hold the matrix band in place and to hold the tension, i.e. hold the matrix band flush against the tooth, for the duration of the procedure.

Many current matrix band retainers are bulky and need to be attached to the matrix band for the duration of the procedure. It is a relatively large object when compared to the amount of space available in the oral cavity. Leaving the retainer in the oral cavity for the duration of the procedure adds to the discomfort experienced by the patient as it hangs out of the mouth.

### SUMMARY OF THE INVENTION

A matrix band and tightening system comprises a matrix band having a circumference and received by a matrix band tightener. The matrix band tightener comprising an actuator and a tensioner, wherein movement of the tensioner and reduction of the matrix band circumference occur at a 1:4 ratio. In another embodiment of the invention the movement of the tensioner and reduction of the matrix band circumference occur at a 1:8 ratio. The matrix band is in a first plane and received by a matrix band tightener comprising an actuator and a tensioner aligned along a first axis, wherein the first axis is parallel to the first plane.

The actuator extends through an interior cavity of the casing and engages the tensioner, and wherein moving the actuator in a first direction displaces the tensioner in the interior cavity of the casing. The tensioner is in communication with the matrix band and continued displacement of the tensioner within the cavity of the casing causes a reduction of the matrix band circumference.

### BRIEF DESCRIPTION OF THE DRAWINGS

FIG. 1 is a perspective view of an embodiment of dental matrix band and tightening system of the present invention;

FIG. 2 is an isometric view of the embodiment of FIG. 1;

FIG. 3 is the bottom plan view of the embodiment of FIG. 1;

FIG. 4 is an exploded isometric view of the embodiment of FIG. 1;

FIG. 5 is a side elevation view of a component of the embodiment of FIG. 1;

FIG. 6 is an isometric view of a component of the embodiment of FIG. 1;

FIG. 7a is a side elevation view of the embodiment of FIG. 1 in a first position;

FIG. 7b is a cross section view of the embodiment of FIG. 1 taken along line A-A of FIG. 7b;

FIG. 8a is a side elevation view of the embodiment of FIG. 1 in a second position;

FIG. 8b is a cross section view of the embodiment of FIG. 1 taken along line B-B of FIG. 8a;

FIGS. 9-11 are isometric views of the embodiment of FIG. 1;

FIG. 13 is a side perspective view of a component of the embodiment of FIG. 10;

FIG. 14 is an isometric view of a component of the embodiment of FIG. 10; and

FIGS. 15-16 show isometric views of a companion device to the embodiment of FIG. 1

### DETAILED DESCRIPTION OF THE DRAWINGS

FIGS. 1-14 show embodiments and features of an inventive dental matrix band and tightening system 10 and FIGS. 15-16 show an embodiment of a companion tool used with the tightening system shown in FIGS. 1-14. Objects of the inventive dental matrix band tightening system include providing a dental matrix band that: (1) is easy to tighten and adjust, (2) does not take up a large amount of space in the oral cavity, (3) does not interfere when the patient bites their teeth together, and (4) maintains the required tension for the duration of the procedure. The inventive system 10 generally comprises a matrix band 12, casing 14, actuator 16, and tensioner 18 (FIG. 4). As seen in FIG. 1, the dental matrix band and tightening system 10 is fitted over a tooth 20 prepared for restoration, e.g., removal of an old restoration and/or decay using standard dental protocol, and preparation of tooth for the required type of restoration. Once the matrix band 12 is in place, standard dental techniques are used to restore the tooth 20.

Turning first to FIGS. 1-8, a first embodiment of the inventive system 10 is shown. The matrix band 12 (FIGS. 4-6) comprises a body 22 having in an open/broken generally circular or rounded configuration having circumference C and terminating at a first and a second end 24, 26, with the base of the first and second ends 24, 26 defining an opening or gap 28 (see also FIG. 2). The first and second ends 24, 26 are essentially identical in configuration and overlap to form a uniform matrix band extension 30. The extension 30 has a first and second leg portion 32a, 32b, 34a, 34b extending from the matrix band body 22 terminating into tip segments 36a, 36b (shown as a tip 36 in FIG. 4). The tip is shown as Li-shaped. The first and second ends 24, 26 each include a uniform cut-out portion 38a, 38b forming a slot 38 configured to avoid interference with the actuator 16 when the system 10 is fully assembled.

The casing 14 is generally cubical with a first, second, and third set of opposing sidewalls 40a, 40b, 42a, 42b, 44a, 44b defining an interior cavity 46. The casing 14 in this embodiment, is made of biocompatible plastic such as polypropylene. As seen in FIGS. 2-4 the first sidewall 40a includes an optional curved section 48 that seats the body portion 22 of the matrix band 12 when system is operation. When the curve 48 feature is present, the radius of curvature of the curved section 48 is selected to urge a gentle curvature to the body portion 22 of the matrix band 12. The first set of opposing sidewalls 40a, 40b includes a first opening 50, in the form of a slot on the first sidewall 40a, disposed towards the center of the curved section 48, and a second opening 52 in the second sidewall 40b, formed by shorting the length of the sidewall 40b to form a gap or void.

The openings 50, 52 are configured to receive the matrix band extension 30 such that during set up and operation of the system 10 the matrix band extension 30 threads through the first opening 50, extends through the interior cavity 46 of the casing 14, and through the second opening 52. As seen in FIGS. 1, 7b, 8b, the second sidewall 40b in the first set of opposing sidewalls includes a first recessed portion/channel 54 to receive and seat the matrix band extension 30 once threaded through the second opening 52.

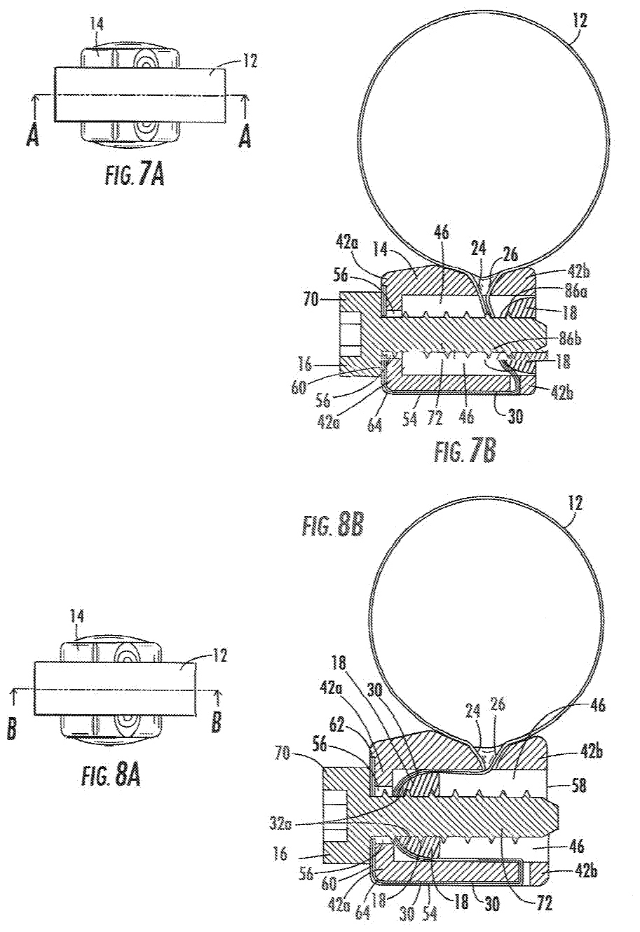

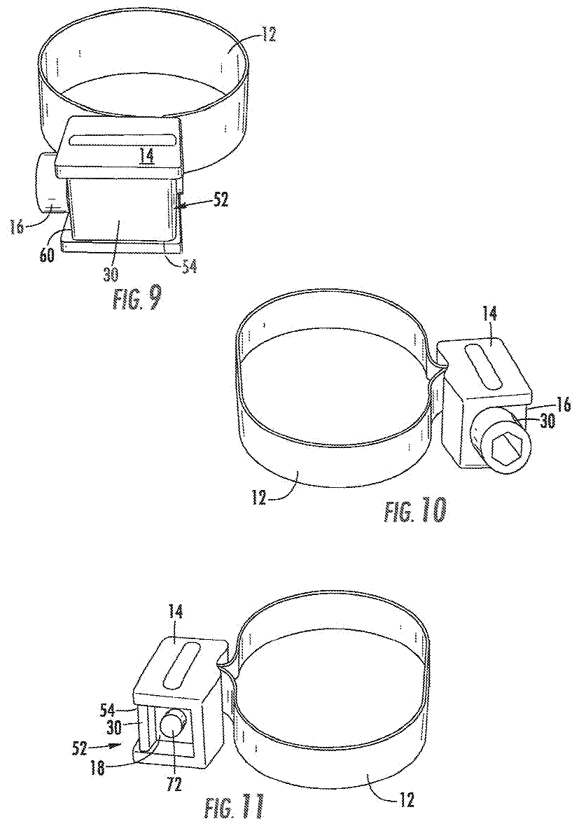

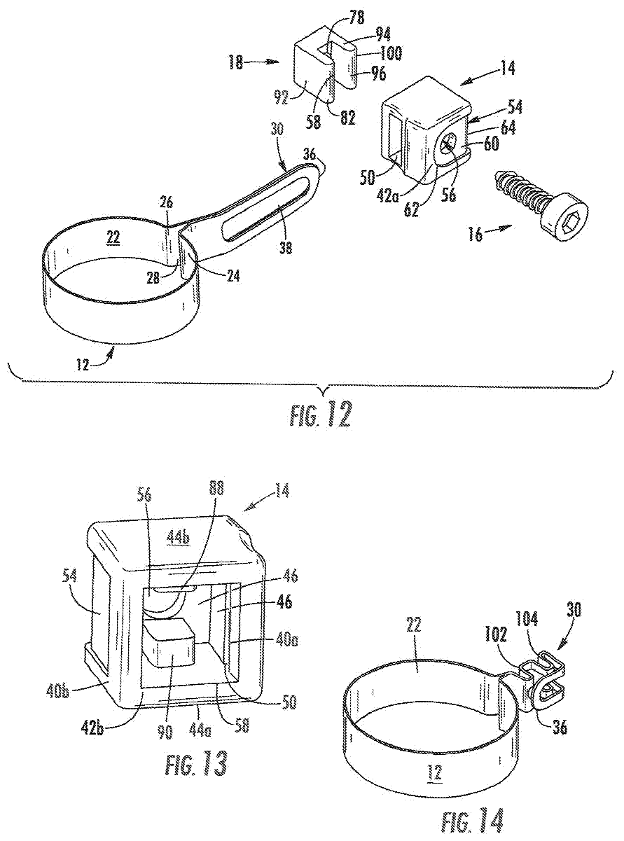

The second set of opposing sidewalls 42a, 42b includes a first bore or opening 56 (FIGS. 7b, 8b and also seen in FIG. 10) on the first sidewall 42a configured to receive the actuator 16 and a second opening 58 on the opposing, second sidewall 42b configured to receive the tensioner 18. In the first sidewall 42a of this pair, the first bore or opening 56 sits in a recessed portion/channel 60 (FIGS. 7b, Sb and FIG. 12) that aligns with the recessed portion/channel 60 in the adjacent sidewall 40b. The end 62 (FIG. 12) of the recessed portion/channel 60 opposite the interface 64 with recessed portion/channel 54 of the adjacent sidewall 40b may replicate the tip 36 of the matrix band extension 30. In this embodiment, the tip 36 and the end 62 are both U-shaped to promote ease of alignment of the components.

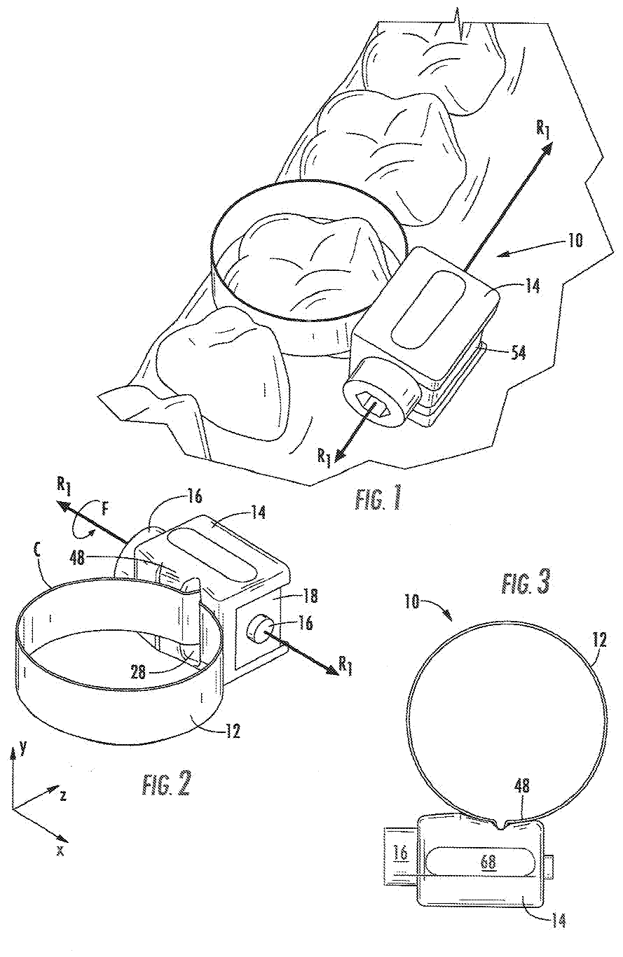

The third set of opposing sidewalls 44a, 44b may include one or more gripping sections to facilitate secure gripping and handling of the casing 14 during operation. As seen in FIGS. 1, 3, the first and second opposing sidewalls each include a gripping section 66, 68 comprising a recessed area. The gripping sections could also comprise roughened surfaces, a gripping ridge or ridges, and the like.

The top of the second opening 52 may further comprise a lateral notch configured to receive the upper strap of the matrix band extension 30 as the matrix band extension 30 extends through the opening 52. In operation, the result of the notch is the upper strap being looser than the bottom strap as the bottom strap travels additional distance. The looser upper straps helps the matrix band body 22 flare outwards at the top.

In FIG. 4, and also FIG. 12, the actuator 16 is a rotary actuator, in the form of a screw, having a head portion 70 and a threaded shaft 72 extending from the head portion 70. The head portion 70 may further comprise a receptor 74 to receive a tool (not shown) to rotate the actuator. As seen in these figures, the receptor 74 is hexagonal shaped to receive a hex key or Allen wrench. The receptor 74 may also be configured to receive a flathead or Phillips head screwdriver, star key, or similar geometric shape. The outer periphery of the head portion 70 can also be shaped to engage a tool for rotating the actuator 16. For example, a hexagonal outer periphery could be received by a wrench or pliers. For simplification of manufacture, the actuator 16 may also be cylindrical.

The threaded shaft 72 inserts through sidewall 42a at the opening 56 and extends through the interior cavity 46. The diameter of the head portion 70 is greater than the diameter of the opening 56 restricting continued insertion of the actuator 16 in the casing 14. In the embodiment of the invention seen in FIGS. 4, 12 the distal end 76 of the threaded shaft 72 engages a central bore 78 in the tensioner 18. The tensioner 18 in these figures comprises a slider drawn into and through the interior cavity 46 as the actuator rotates in a first direction (F in FIG. 2). In FIG. 4, the tensioner 18 comprises a slider having back portion 80 and a first engagement surface 82 opposite the back portion 80. In this embodiment the first engagement surface 82 is a semi-circular, arced surface with the apex 84 of the arced surface including a first and second contact point 86a, 86b (FIG. 7b, 8b) on opposite sides of the central bore 78. As seen best in FIGS. 7b, 8b, the first and second contact points 86a, 86b engage the first leg portion 32a of the matrix band extension 30. The configuration of the interior cavity 46 and back portion 80 of the tensioner 18 are selected to prevent rotation of the tensioner 18 within the casing 14. Rotation of the actuator 16 in a first direction draws the tensioner 18 into the casing 14, up the threaded shaft 72 towards the sidewall 42a.

Referring to FIGS. 1-8, with focus on FIGS. 7b, 8b, the system operates by threading the matrix band extension 30 through the first opening 50, through the interior cavity 46, and then through the second opening 52. The matrix band extension 30 is then wrapped around the casing 14 through the recessed portion/channel 54 in the sidewall 40b, and into the recessed portion/channel 60 on the sidewall 42a. The tip 36 of the matrix band extension extends into the contoured end 62 (FIG. 12) of the recessed portion/channel 60. The actuator 16 extends through the portion of the matrix slot 38 in the recessed portion/channel 60, through the opening in sidewall 42a, into the interior cavity 46 of casing 14 and through the slot 38 in the matrix band extension 30. The tensioner 18 inserts into the interior cavity 46 of the casing 14 through the opening 52 in sidewall 42b and the distal end 76 of the threaded shaft 72 engages the central bore 78 of the tensioner 18.

Rotating the actuator 16 in a first direction F (FIG. 2) draws the tensioner 18 up the threaded shaft 72 towards the sidewall 40b and through the interior cavity 46 of the casing 14 along rotation axis R1 (FIG. 2). As the tensioner 18 proceeds up the threaded shaft 72, the contact points 86a,86b of the first engagement surface 80 address the first and second legs 32a, 34a of the matrix band extension 30 and pull the matrix band 12 further into the casing 14. As more of the matrix band 12 is drawn into the casing 14, the gap 28 (FIGS. 2, 4) in the matrix band 12 closes, the matrix band 12 seats in the curved portion 48 of the sidewall 40a, and tightens around the tooth 20 being restored (FIG. 1).

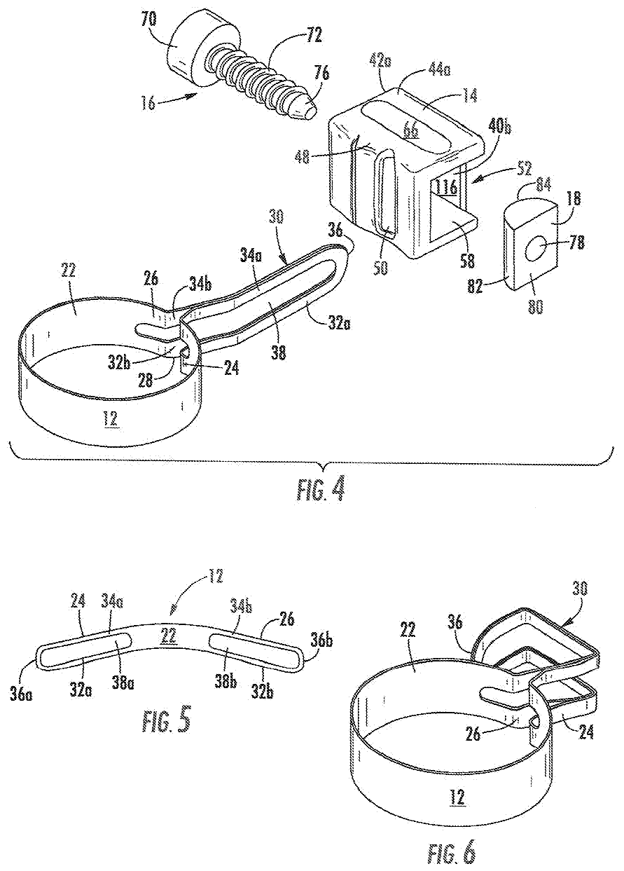

When the tensioner 18 is drawn completely through the interior cavity 46 and the matrix band extension 30 becomes sandwiched between the tensioner 18 and inside of the sidewall 42a, the matrix band 12 is fully tightened and secured in position against the tooth being restored 20. FIG. 6 shows the matrix band extension 30 in an intermediate configuration where the matrix band extension 30 has been inserted through the wrapped around the casing 14 and before the tensioner acts on the matrix band.

One notable feature of this design is the four-fold gearing gain, namely, the uptake of the matrix band is four (4) times the movement of the tensioner 18 in the casing 14. For each 1 mm of travel of the tensioner 18 within the casing 14, the circumference C of the matrix band is reduced by 4 mm. This results from both the first and second end 24, 26 of the matrix band passing around the tensioner 18. As shown in FIG. 2, the actuator 16 and tensioner 18 align along axis of rotation R1. To promote ease of access to the actuator 18 and operation of the system 10, R1 is coplanar with the plane of the matrix band 12 (FIG. 2-X-Z plane) and is generally parallel to the mesial-distal alignment of the teeth (FIG. 1).

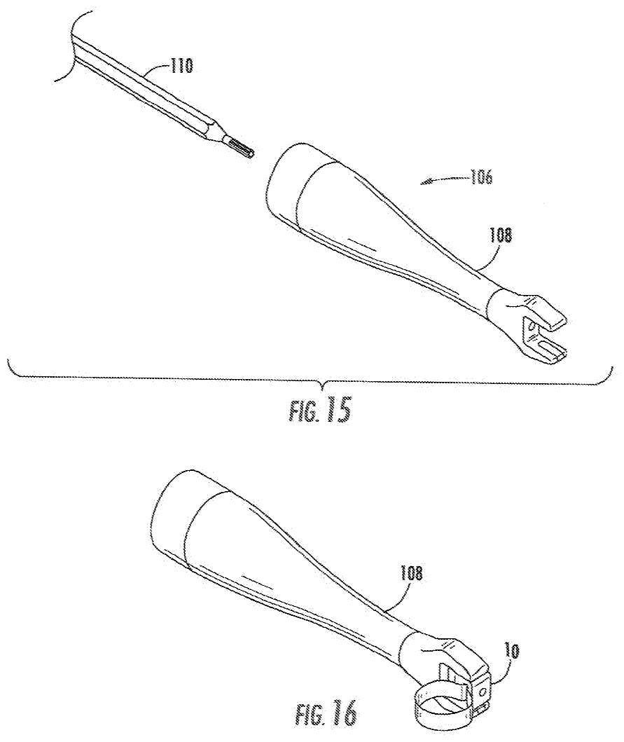

FIGS. 12-14 show a second embodiment of the present inventive system 10 with modified casing 14, and tensioner 16 configurations, as compared with comparable components in FIG. 4. The casing 14 is generally cubical with a first, second, and third set of opposing sidewalls 40a, 40b, 42a, 42b, 44a, 44b defining an interior cavity 46 and is made of biocompatible plastic such as polypropylene. Within the interior cavity 46 is disposed a first and second lug 88, 90 to assist in securing the matrix band extension 30 in place during operation. To engage matrix band extension 30 uniformly and consistently, the lugs 88, 90 are located on opposite sides of the opening 56 on the inner surface of the sidewall 42a. The tensioner 18 this embodiment is a slider having a first engagement surface 82 on a first prong 92 and a second engagement surface 96 on a second prong 108. The first engagement surface 80 terminates at a first contact point 98 and the second engagement surface 96 terminates at a second contact point 100. The multi-prong tensioner 18 structure, with first and second contact points 98, 100, and added lugs 88, 90 in the tensioner body 14 result furthering securing of the matrix band 12 in a tightened state during operation of the system. As seen in FIG. 14, the matrix band extension 30 will conform to include a first and second kink or indentation 102, 104 that correspond to the first and second prongs 92, 94 of the tensioner 18. A notable feature of this design is the approximately eight-fold gearing gain, namely, the uptake of the matrix band is eight (8) times the movement of the tensioner 18 in the casing 14. For each 1 mm of travel of the tensioner 18 within the casing 14, the circumference C of the matrix band is reduced by 8 mm.

FIGS. 13-14 show a companion tool 106 to be used with the embodiments of the invention shown in FIGS. 1-12. The tool 106 comprises a holding element 108 to receive the casing 14. A driver bit 110 inserts through the tool body 124 and engages the receptor of the actuator. Turning the driver bit 110 in a first direction rotates the actuator, draws the tensioner in to the casing, and tightens the matrix band around the tooth being restored. A manual wheel or electric screwdriver can be used to turn the driver bit 110.

While the present invention has been described in connection with a specific application, this application is exemplary in nature and is not intended to be limiting on the possible applications of this invention. It will be understood that modifications and variations may be effected without departing from the spirit and scope of the present invention. It will be appreciated that tile present disclosure is intended as an exemplification of the invention and is not intended to limit the invention to the specific embodiments illustrated and described. The disclosure is intended to cover, by the appended claims, all such modifications as fall within the scope of the claims.

1. A matrix band and tightening system comprising:
a. a matrix band having a circumference and received by a matrix band tightener; and
b. the matrix band tightener comprising an actuator and a tensioner, wherein movement of the tensioner and reduction of the matrix band circumference occur at a 1:4 ratio.

2. The system of claim 1 wherein the matrix band further comprises a first extension and the first extension is received by matrix band tightener.

3. The system of claim 1 wherein the matrix band tightener comprises a casing having a first opening for receiving the actuator and a second opening for receiving the tensioner.

4. The system of claim 3 wherein the first opening for receiving the actuator and second opening for receiving the tensioner are on opposing sides of the casing.

5. The system of claim 4 wherein the actuator extends through an interior cavity of the casing and engages the tensioner, and wherein moving the actuator in a first direction displaces the tensioner in the interior cavity of the casing.

6. The system of claim 5 wherein the actuator is a rotary actuator and applying a first rotation force to the actuator draws the tensioner into the interior cavity of the casing.

7. The system of claim 5 wherein the tensioner is in communication with the matrix band and continued displacement of the tensioner within the cavity of the casing causes a reduction of the matrix band circumference.

8. The system of claim 2 wherein the matrix band tightener comprises a casing having a first opening for receiving the matrix band extension to provide ingress of the matrix band extension into an interior cavity of the casing and a second opening for receiving the matrix band extension to provide egress of the matrix band extension from the interior cavity.

9. The system of claim 8 wherein the first opening for receiving the matrix band extension comprises a slot.

10. The system of claim 8 wherein the second opening for receiving the matrix band is formed from a shortened sidewall and forms a gap between adjacent sidewalls.

11. The system of claim 8 wherein the first and second openings are disposed on opposite sidewalls of the casing.

12. The system of claim 8 wherein the actuator anchors the matrix band to a sidewall of the casing by the actuator, and wherein the displacement of the tensioner through the interior cavity of the casing reduces the circumference of the matrix band.

13. A matrix band tightener comprising: a casing with a first and second matrix band receiving opening, an actuator acting on a tensioner to draw the tensioner into an interior cavity of the casing, and the tensioner comprising at least a first matrix band contact point wherein drawing the tensioner into the interior cavity of the casing causes the tensioner to move across the first and second matrix band receiving openings.

14. The system of claim 13 wherein the casing has a first opening for receiving the actuator and a second opening for receiving the tensioner on opposing sidewalls of the casing.

15. The system of claim 13 wherein the actuator extends through the interior cavity of the casing and engages the tensioner, and wherein moving the actuator in a first direction draws the tensioner into the interior cavity of the casing.

16. The system of claim 15 wherein the actuator is a rotary actuator and applying a first rotation force to the actuator draws the tensioner into the interior cavity of the casing.

17. The system of claim 13 wherein the first matrix band receiving opening comprises a slot.

18. The system of claim 17 wherein first matrix band receiving opening is displaced on a curved section of a casing sidewall.

19. The system of claim 13 wherein the second matrix band receiving opening is formed from a shortened sidewall and forms a gap between adjacent sidewalls.

20. The system of claim 13 wherein the first and second matrix band receiving openings are disposed on opposite sidewalls of the casing.

21. A matrix band and tightening system comprising:
a. a matrix band having a circumference and received by a matrix band tightener; and
b. the matrix band tightener comprising an actuator and a tensioner, wherein movement of the tensioner and reduction of the matrix band circumference occur at a 1:8 ratio.

22. The system of claim 21 wherein the matrix band further comprises a first extension and the first extension is received by matrix band tightener.

23. The system of claim 21 wherein the matrix band tightener comprises a casing having a first opening for receiving the actuator and a second opening for receiving the tensioner.

24. The system of claim 23 wherein the first opening for receiving the actuator and second opening for receiving the tensioner are on opposing sides of the casing.

25. The system of claim 24 wherein the actuator extends through an interior cavity of the casing and engages the tensioner, and wherein moving the actuator in a first direction displaces the tensioner within the interior cavity of the casing.

26. The system of claim 25 wherein the actuator is a rotary actuator and applying a first rotation force to the actuator displaces the tensioner within the interior cavity of the casing.

27. The system of claim 25 wherein the tensioner is in communication with the matrix band and displacement of the tensioner within the interior cavity of the casing causes a reduction of the matrix band circumference.

28. The system of claim 22 wherein the matrix band tightener comprises a casing having a first opening for receiving the matrix band extension to provide ingress of the matrix band extension into an interior cavity of the casing and a second opening for receiving the matrix band extension to provide egress of the matrix band extension from the interior cavity.

29. The system of claim 28 wherein the first opening for receiving the matrix band extension comprises a slot.

30. The system of claim 28 wherein the second opening for receiving the matrix band is formed from a shortened sidewall and forms a gap between adjacent sidewalls.

31. The system of claim 28 wherein the first and second openings are disposed on opposite sidewalls of the casing.

32. The system of claim 28 further comprising a first and second lug disposed in the interior of a sidewall of the casing.

33. A matrix band tightening system comprising:
a. a matrix band in a first plane and received by a matrix band tightener; and
b. the matrix band tightener comprising an actuator and a tensioner aligned along a first axis, wherein the first axis is parallel to the first plane.

34. The system of claim 33 wherein the matrix band has a circumference and applying a first force to the actuator results in displacement of the tensioner along the first axis and reduction of the matrix band circumference.

35. The system of claim 34 wherein the actuator is a rotary actuator and the first force rotates the actuator about the first axis.

36. The system of claim 35 wherein the tensioner is displaced along the first axis towards the actuator.

37. The system of claim 36 further comprising a casing housing the actuator and tensioner, wherein the matrix band extends through the casing and is anchored to a sidewall of the casing by the actuator, and wherein the displacement of the tensioner through an interior cavity of the casing reduces the circumference of the matrix band.
